(19) United States
(12) Patent Application Publication
(10) Pub. No.: US 2009/0070155 A1
(43) Pub. Date: Mar. 12, 2009

(54) AUTOMATED METHOD TO MANAGE RENTAL UNITS, HOTEL ROOMS, OR GUEST SUITES

(76) Inventor: Marlyn Zonnefeld, Tucson, AZ (US)

Correspondence Address: DALE F. REGELMAN, QUARLES & BRADY, LLP, ONE SOUTH CHURCH AVENUE AVE, STE. 1700, TUCSON, AZ, 85701-1621, US

(21) Appl. No.: 12/208,271

(22) Filed: Sep. 10, 2008

Related U.S. Application Data
(60) Provisional application No. 60/971,195, filed on Sep. 10, 2007.

(51) Int. Cl. G06Q 10/00; G06Q 50/00; G06Q 20/00

(52) U.S. Cl. 705/5

(57) ABSTRACT

A method to manage a plurality of guest rental units, wherein the method provides a plurality of guest rental units, wherein each guest rental unit comprises one or more bed rooms and a bath room. The method further disposes a different rental kiosk adjacent to, and associated with, each guest rental unit, displays on each rental kiosk a vacancy status for a designated guest rental unit, and accepts a rental payment at each rental kiosk for a designated guest rental unit. In certain embodiments, the method displays upon request the availability of a rental unit in accordance with a previous reservation made by the traveler. The kiosk displays this availability, and upon approval of the travelers credit card, assigns a room or rental unit to the traveler and enables said travelers credit card to also enable a locking device on the room or rental unit to permit entry to the traveler.

### CROSS-REFERENCE TO RELATED APPLICATIONS

This Application claims priority from a U.S. Provisional Application having Ser. No. 60/971,195, filed Sep. 10, 2007.

### FIELD OF THE INVENTION

The invention is directed to an automated method to manage rental units, hotel rooms, or guest suites.

### BACKGROUND OF THE INVENTION

Traditionally, a traveler looking for overnight accommodations first locates a motel or hotel, hostel, bed and breakfast, and or any other similar traveler hosting facility, arrives via commercial transportation, rental car, or public transportation and or, parks at a motel office, determines if the motel has available rooms at an acceptable price, signs a rental agreement of some sort, returns to his/her vehicle, and finally attempts to find the correct motel room.

If the traveler arrives late at night, motel and or hotel, hostel, bed and breakfast, and or any other similar traveler hosting facility, personnel might not be readily available to complete the rental transaction, thereby forcing the weary traveler to wait for an extended period time. If the traveler arrives during inclement weather, it is inconvenient to park the vehicle, exit the vehicle, lock the door(s), return to the vehicle, unlock the doors, multiple times during that inclement weather.

### SUMMARY OF THE INVENTION

What is needed is a method wherein a traveler can locate a convenient guest rental unit, determine is that guest rental unit is available without leaving his/her vehicle, pay for lodging at that guest rental unit without leaving his/her vehicle, and park the vehicle inside a garage without the need to first open a garage door. In addition this invention would facilitate a traveler arriving at a hostel, hotel, motel, bed and breakfast, and ro other commercial hosting facility by enabling the traveler to check in, guarantee payment, and secure entry to his or her room or suite without having to interact with hotel or motel personnel to perform this task, eliminating overhead costs for the establishment owner entity, while greatly enhancing the travelers convenience in obtaining and checking into his room or suite.

Applicant's invention comprises an apparatus and method to manage a plurality of guest rental units. The method provides a plurality of guest rental units, wherein each guest rental unit comprises one or more bed rooms and a bath room. The method further disposes a different rental kiosk adjacent to, and associated with, each guest rental unit, displays on each rental kiosk a vacancy status for a designated guest rental unit, and accepts a rental payment at each rental kiosk for a designated guest rental unit. This information could also be displayed on a lobby kiosk apparatus that would enable the checkin process, room selection, and room or suite entry using the traveler's credit card as the entry device, rather than an additional unnecessary step of securing a key.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates one embodiment of Applicant's guest rental complex;

FIG. 2 is a perspective view of one of Applicant's guest rental units;

FIG. 3A illustrates one embodiment of a surface of Applicant's rental kiosk;

FIG. 3B is a block diagram illustrating additional elements disposed in Applicant's rental kiosk;

FIG. 4 is a perspective view of the guest rental unit of FIG. 2 with a garage door open; and

FIG. 5 is a flow chart summarizing the steps of Applicant's method.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In certain embodiments, Applicant's invention comprises an apparatus and method, wherein a traveler can locate a convenient guest rental unit, determine if that guest rental unit is available for the night without leaving his/her vehicle, pay for lodging at that guest rental unit without leaving his/her vehicle, and park the vehicle inside a garage without the need to first open a garage door.

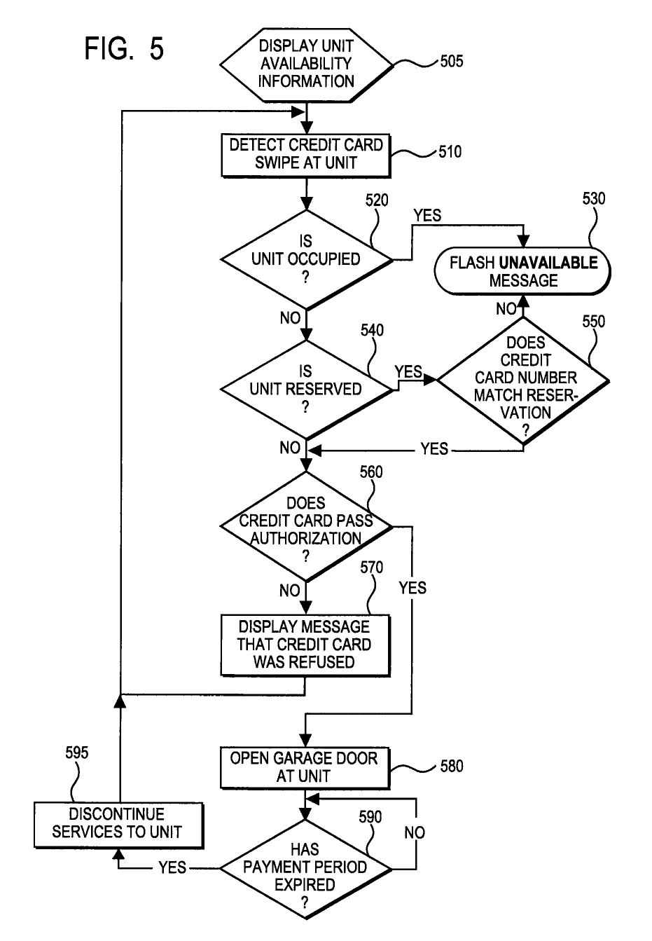

Applicant's invention is described herein in a “motel-type” implementation, wherein a rental complex comprises a plurality of individual and separate rental units each comprising a driveway. This description of Applicant's invention should not be taken to limit the invention to such motel-type embodiments. Applicant's method summarized in FIG. 5 may be implemented in hotel embodiments as well.

Applicant's invention comprises a plurality of rental units, and an automated method whereunder each rental unit comprises a visual display device which displays the rental status of the unit, and a rental kiosk at which a patron may contract for the rental of a unit, if available, for one or a plurality of designated time periods. In certain embodiments, each rental unit comprises a living space in combination with a garage.

In certain embodiments, the living space comprises a single bed room and a bath room. In certain embodiments, the living space comprises a plurality of bed room and one or more bath rooms. In certain embodiments, the living space comprises a plurality of bed rooms, a plurality of bath rooms, and a living room.

In certain embodiments, Applicant's apparatus and method provides a plurality of guest services in combination with the afore-described living space. In certain embodiments, the guest services include one or more of the group comprising cable/satellite television reception, Internet connectivity, on-demand movies, food catering, and the like.

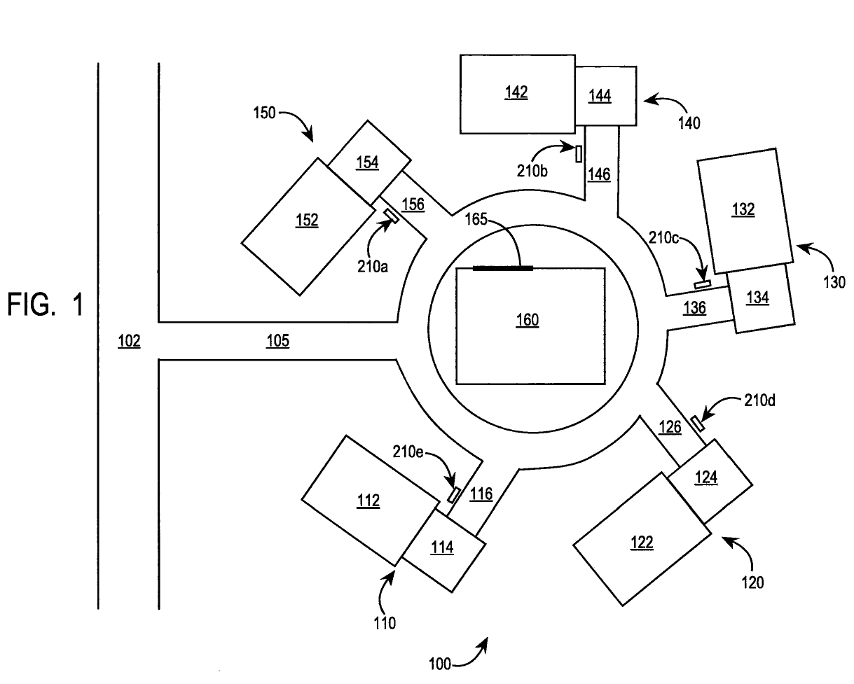

In the illustrated embodiment of FIG. 1, Applicant's rental unit complex 100 comprises rental unit 110, rental unit 120, rental unit 130, rental unit 140, and rental unit 150. Further in the illustrated embodiment of FIG. 1, rental unit complex 100 comprises entry way 105 which interconnects rental complex 100 with roadway 102. In the illustrated embodiment of FIG. 1, each guest rental unit is associated with a different rental kiosk 210, i.e. rental kiosk 210a/guest rental unit 150, rental kiosk 210b/guest rental unit 140, rental kiosk 210c/guest rental unit 130, rental kiosk 210d/guest rental unit 120, and rental kiosk 210e/guest rental unit 110.

Further in the illustrated embodiment of FIG. 1, guest rental unit complex 100 comprises gated common area 160, wherein entry to common area 160 is controlled by gate 165. In certain embodiments, gate 165 is activated by use of a credit card used to rent one or more of the guest rental units 110 through 150, inclusive. In certain embodiments, common area 160 may include one or more recreational facilities, such as and without limitation a swimming pool, Jacuzzi, volley ball court, and the like.

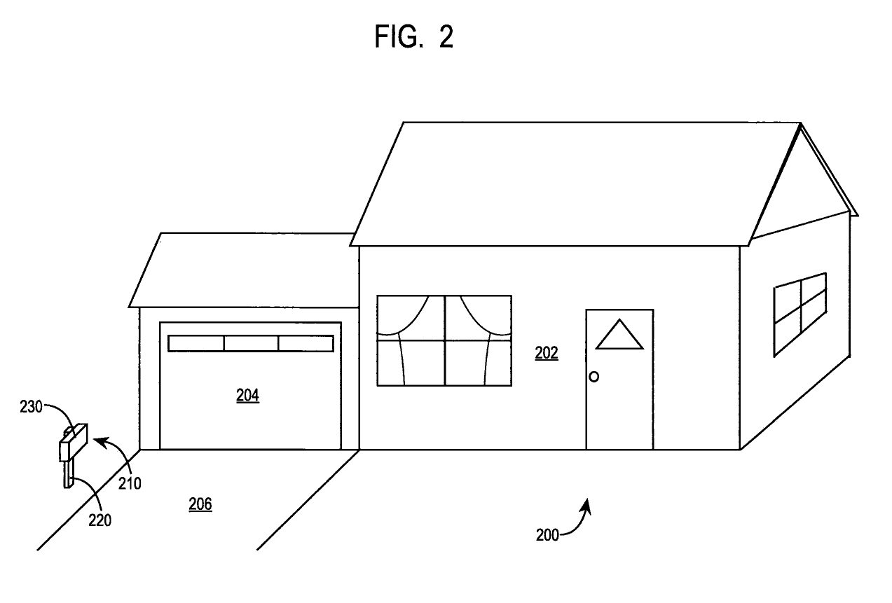

FIG. 2 is a perspective view of Applicant's guest rental unit 200. In certain embodiments, each of guest rental units 110 through 150, inclusive, comprises a separate guest rental unit 200. Guest rental unit 200 comprises living space 202, garage 204, and driveway 206.

Rental kiosk 210 is disposed adjacent driveway 206. Rental kiosk comprises surface 230 which faces driveway 206. In the event a vehicle enters drive way 206, surface 230 of rental kiosk 210 faces the vehicle driver.

In hotel embodiments, a rental kiosk is mounted adjacent to each available room/suite available in the hotel. In certain of these hotel embodiments, Applicant's rental kiosk is mounted within a wall with only surface 230 visible to hotel guests.

Certain of the functional units disposed in Applicant's rental kiosk have been labeled as modules (e.g., modules 355 and 395) in order to more particularly emphasize their implementation independence. For example, a module (e.g., modules 355 and 395) may be implemented as a hardware circuit comprising custom VLSI circuits or gate arrays, off-the-shelf semiconductors such as logic chips, transistors, or other discrete components. A module (e.g., modules 355 and 395) may also be implemented in programmable hardware devices such as field programmable gate arrays, programmable array logic, programmable logic devices, or the like.

Modules (e.g., modules 355 and 395) may also be implemented in software for execution by various types of processors. An identified module of executable code may, for instance, comprise one or more physical or logical blocks of computer instructions which may, for instance, be organized as an object, procedure, or function. Nevertheless, the executables of an identified module (e.g., 355 and/or 395) need not be physically collocated, but may comprise disparate instructions stored in different locations which, when joined logically together, comprise the module and achieve the stated purpose for the module.

Indeed, a module of executable code (e.g., modules 355 and/or 395) may be a single instruction, or many instructions, and may even be distributed over several different code segments, among different programs, and across several memory devices. Similarly, operational data may be identified and illustrated herein within modules, and maybe embodied in any suitable form and organized within any suitable type of data structure. The operational data may be collected as a single data set, or may be distributed over different locations including over different storage devices, and may exist, at least partially, merely as electronic signals on a system or network.

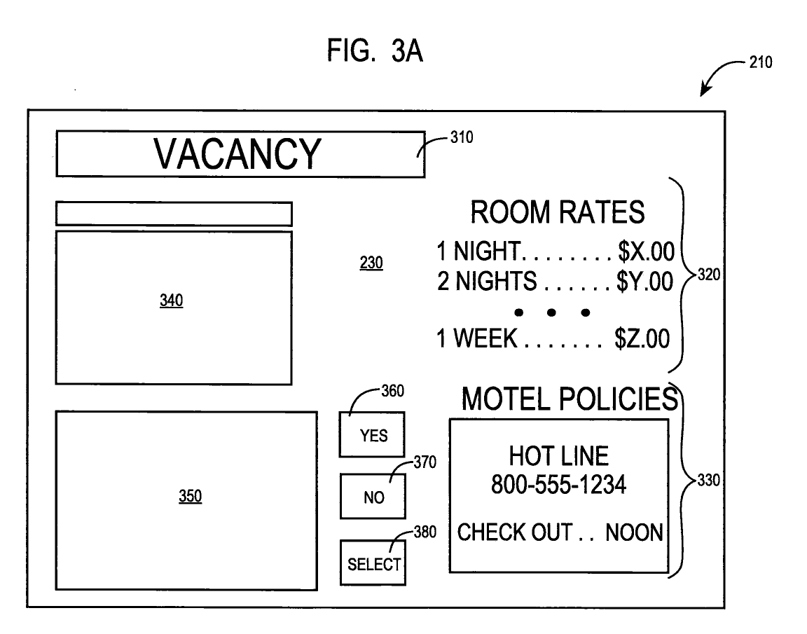

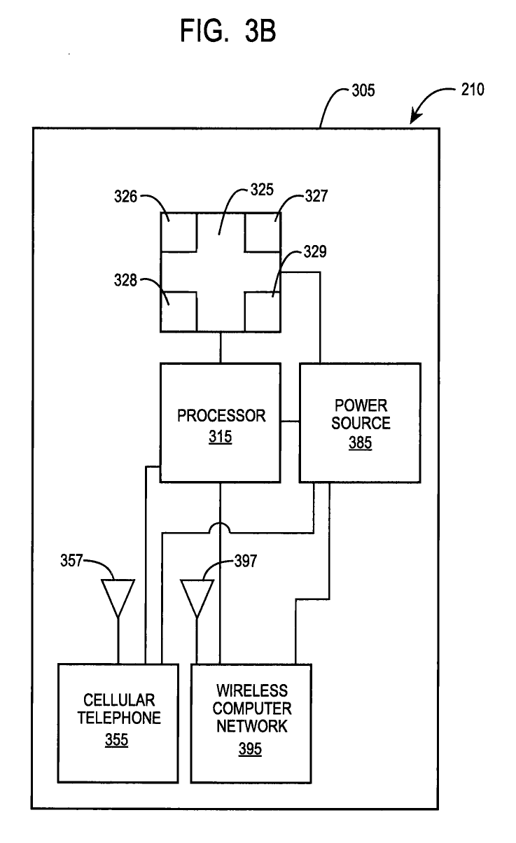

In the illustrated embodiment of FIG. 3A, surface 230 of rental kiosk 210 comprises a visual display device 310. In certain embodiments, visual display device 310 comprises a liquid crystal display (“LCD”). In the illustrated embodiment of FIG. 3, visual display device 310 reads VACANCY. In other embodiments, visual display device reads OCCUPIED or RESERVED. Referring to FIGS. 1 and 3, a vehicle operator can ascertain the rental status of each of guest rental units 110, 120, 130, 140, and 150, by reading the status message shown on a rental kiosk associated with each of those guest rental units.

In the illustrated embodiment of FIG. 3A, surface 230 of rental kiosk 210 further comprises information 320 comprising, inter alia, rental rates data. In the illustrated embodiment of FIG. 3, surface 230 of rental kiosk 210 further comprises information 330 comprising, inter alia, motel policies, telephone contact information, check out times, and the like.

In the illustrated embodiment of FIG. 3, surface 230 of rental kiosk 210 further comprises a credit card magnetic strip reading device 340, visual display device 350, and input devices 360, 370, and 380. In certain embodiments, visual display device 350 comprises a touch screen, and input devices 360, 370, and 380, comprise separate touch screen elements.

In certain embodiments, Applicant's rental kiosk comprises a single visual display device. In these embodiments, the guest rental unit status information of step 505 (FIG. 5) is displayed on visual display device 350.

Referring now to FIG. 3B, in certain embodiments Applicant's rental kiosk 210 comprises housing 305. In the illustrated embodiment of FIG. 3B, processor 315, power source 385, memory 325, cellular telephone module 355, and wireless computer network interface 395, are disposed within housing 305. Credit card magnetic strip reading device 340, visual display device 350, and input devices 360, 370, and 380, are interconnected with processor 315 and power source 385.

In certain embodiments, power source 385 comprises a power supply apparatus that receives input power of about 115 VAC and converts that input power to output power of ±5VDC and ±12VDC. In certain embodiments, power source 385 comprises a plurality of batteries.

In certain embodiments, rental rate information 326, reservation database 327, operating system/microcode 328, and instructions 329, are encoded in memory 325. Processor 315 utilizes microcode/operating system 328 to operate rental kiosk 310.

In certain embodiments, Applicants rental kiosk further comprises antenna 357 which is interconnected with cellular telephone module 355. In certain embodiments, Applicant's rental kiosk 310 further comprises antenna 397 which is interconnected with wireless computer network interface module 395. Rental kiosk 310 receives updated rental rate information 326 via cellular telephone module 355 and/or wireless computer network 395, wherein processor 315 writes that updated rental information to memory 325. Rental kiosk 310 receives updated guest rental unit reservation information via cellular telephone module 355 and/or wireless computer network 395, wherein processor 315 writes that updated guest rental unit reservation information to reservation database 327.

FIG. 5 summarizes the steps of Applicant's method. Referring now to FIG. 5, in step 505 the method visually displays the rental status of a rental unit/hotel room/suite, such as for example and without limitation rental unit 200 (FIG. 2), or a room/suite in a hotel. In certain embodiments, the rental status information is displayed on a visual display device, such as device 310, disposed on a rental kiosk, such as rental kiosk 210. In certain embodiments, the rental status information is displayed on a visual display device, such as device 350, disposed on a rental kiosk, such as rental kiosk 210.

In step 510, the method detects a credit card swipe at a credit card magnetic strip reader, such as credit card magnetic strip reader 340. In step 520, the method determines if the rental unit/hotel room/suite associated with the credit card magnetic strip reader of step 510 is occupied.

If the method determines in step 520 that the rental unit/hotel room/suite associated with the credit card magnetic strip reader of step 510 is occupied, then the method transitions from step 520 to step 530 wherein the method causes the visual display device of step 505 to display a message that the rental unit/hotel room/suite is unavailable. If the method determines in step 520 that the rental unit/hotel room/suite associated with the credit card magnetic strip reader of step 510 is not occupied, then the method transitions from step 520 to step 540 wherein the method determines if that rental unit/hotel room/suite is reserved.

If the method determines in step 540 that the requested rental unit/hotel room/suite is reserved, then the method transitions from step 540 to step 550 wherein the method determines if the credit card information determined in step 510 matches credit card information recited in a reservation for the requested rental unit/hotel room/suite. If the method determines in step 550 that the credit card information determined in step 510 does not match the credit card information recited in a reservation for the requested rental unit/hotel room/suite, then the method transitions from step 550 to step 530 wherein the method causes the visual display device of step 505 to display a message that the rental unit/hotel room/suite is unavailable.

Alternatively, if the method determines in step 550 that the credit card information determined in step 510 does match the credit card information recited in a reservation for the requested rental unit/hotel room/suite, then the method transitions from step 550 to step 560 wherein the method determines, using a visual display device such as visual display device 350 and input buttons 360, 370, and 380, the number of persons in the rental party, the length of the requested rental term, the zero or more optional services requested, and the like. In certain embodiments, Applicant's method displays a menu-driven series of displays, wherein the user scrolls through that menu, and indicates certain selections, using input buttons 360, 370, and 380.

Further in step 560, the method determines if the credit card of step 510 is authorized for the rental charges calculated using the services selected by the user in step 560. If the method determines in step 560 that the proffered credit card was refused, then the method transitions from step 560 to step 570 wherein the method displays a message that the proffered credit card was refused. Applicant's method transitions from step 570 to step 510 and continues as described herein.

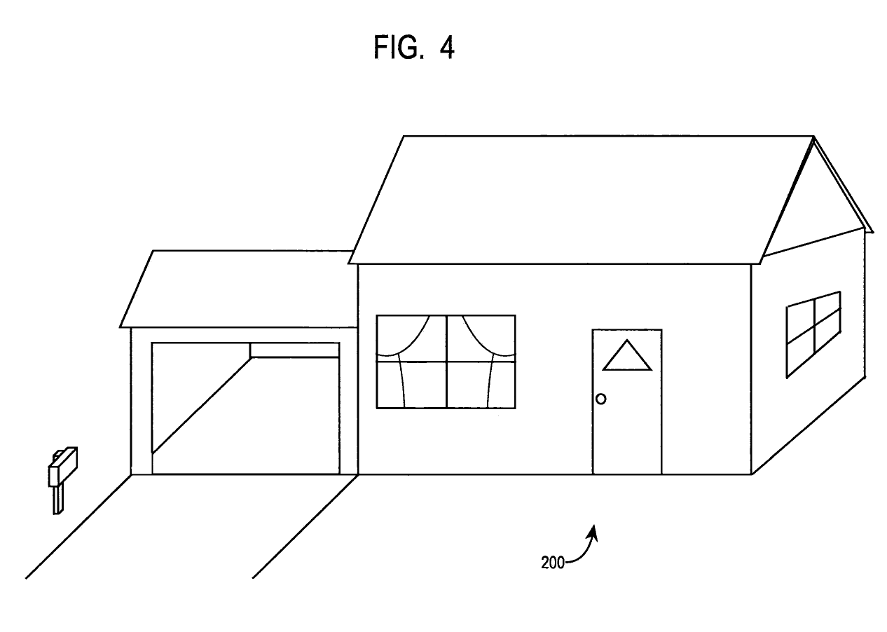

Alternatively and referring now to FIGS. 4 and 5, if the method determines in step 560 that the proffered credit card was accepted, then the method transitions from step 560 to step 580 wherein the method, in certain motel embodiments causes the garage door element of the requested rental unit/hotel room/suite to open. In hotel implementations, if the method determines in step 560 that the proffered credit card was accepted, then the method transitions from step 560 to step 580 wherein the method causes the door of the requested room/suite to open.

In step 580, the method determines if the payment period selected and paid for in step 560 has expired. If the method determines in step 580 that the payment period has not expired, then the method continues to monitor the expiration of the payment period.

Alternatively, if the method determines in step 590 that the payment period selected and paid for in step 560 has expired, then the method discontinues all services to the rental unit/hotel room/suite. The method transitions from step 590 to step 510 and continues as described herein.

In certain embodiments, step 590 comprises discontinuing electrical service to the rental unit/hotel room/suite. In certain embodiments, step 590 comprises discontinuing heating service to the rental unit/hotel room/suite. In certain embodiments, step 590 comprises discontinuing air conditioning service to the rental unit/hotel room/suite. In certain embodiments, step 590 comprises discontinuing Internet service to the rental unit/hotel room/suite. In certain embodiments, step 590 comprises discontinuing television service to the rental unit/hotel room/suite.

In certain embodiments, individual steps recited in FIGS. 2, 3, and/or 4 may be combined, eliminated, or reordered.

In certain embodiments, Applicant's invention includes instructions, such as instructions 113 (FIG. 1) written to computer readable medium 111 (FIG. 1), where those instructions are executed by a processor, such as processor 116 (FIG. 1), to perform one or more of steps 210, 220, 230, 240, 250, 260, 270, 280, 290, and/or 295, recited in FIG. 2, and/or one or more of steps 310, 315, 320, 325, 330, 335, 340, 345, 350, 360, 365, 370, and/or 380, recited in FIG. 3.

In other embodiments, Applicant's invention includes instructions, such as instructions 329, encoded in a computer readable medium such as memory 325, where those instructions are executed by a processor, such as processor 315, to perform one or more of steps 505, 510, 520, 530, 540, 550, 560, 570, 580, 590, and/or 595 recited in FIG. 5. The instructions may be encoded in a computer readable medium comprising, for example, a magnetic information storage medium, an optical information storage medium, an electronic information storage medium, and the like. By “electronic storage media,” Applicant means, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention.

I claim:

1. A method to manage a plurality of guest rental units, comprising:
providing a plurality of guest rental units, wherein each guest rental unit comprises one or more bed rooms and a bath room;
disposing a different rental kiosk adjacent to, and associated with, each guest rental unit;
displaying on each rental kiosk a vacancy status for one guest rental unit;
accepting a rental payment at each rental kiosk for one guest rental unit.

2. The method of claim 1, further comprising displaying by each rental kiosk guest rental unit rental rates.

3. The method of claim 2, wherein each rental kiosk comprises a visual display device, wherein said displaying steps are performed using said visual display device.

4. The method of claim 3, wherein each rental kiosk comprises a credit card magnetic strip reading device, wherein said accepting a rental payment step further comprises obtaining a credit card number using said credit card magnetic strip reading device.

5. The method of claim 4, wherein obtaining step is performed at a rental kiosk associated with one of said plurality of guest rental units, said method further comprising:
determining if said credit card number matches a credit card number recited in a current reservation for said associated guest rental unit;
operative if said credit card number does not match a credit card number recited in a current reservation for said associated guest rental unit, displaying UNAVAILABLE on said visual display device.

6. The method of claim 5, further comprising:
operative if said credit card number matches a credit card number recited in a current reservation for said associated guest rental unit:
calculating a charge to rent said associated guest rental unit; and
determining if said credit card number is authorized for said charge;
operative if said credit card number is authorized for said charge, receiving payment for said charge using said credit card number.

7. The method of claim 6, further comprising operative if said credit card number is not authorized for said charge, displaying a message on said visual display device that said credit card was refused.

8. The method of claim 6, wherein said associated guest rental unit comprises a garage comprising a garage door, further comprising opening said garage door.

9. The method of claim 9, further comprising providing electrical service to said associated guest rental unit.

10. The method of claim 9, further comprising:
determining if a payment period for said associated guest rental unit has expired,
operative if a payment period for said associated guest rental unit has expired, discontinuing said electrical service.

11. An article of manufacture comprising a processor and a computer readable medium having computer readable program code disposed therein to manage a guest rental unit, the computer readable program code comprising a series of computer readable program steps to effect:
displaying a vacancy status for said guest rental unit;
accepting a rental payment for said guest rental unit.

12. The article of manufacture of claim 1, wherein said computer readable program code further comprises a series of computer readable program steps to effect displaying guest rental unit rental rates.

13. The article of manufacture of claim 12, further comprising a visual display device, wherein said computer readable program code to display said guest rental unit rental rates further comprises a series of computer readable program steps to effect displaying said guest rental unit rental rates using said visual display device.

14. The article of manufacture of claim 13, further comprising a credit card magnetic strip reading device, wherein said computer readable program code to accept a rental payment step further comprises a series of computer readable program steps to effect obtaining a credit card number using said credit card magnetic strip reading device.

15. The article of manufacture of claim 14, wherein said computer readable program code further comprises a series of computer readable program steps to effect:
determining if said credit card number matches a credit card number recited in a current reservation for said guest rental unit;
operative if said credit card number does not match a credit card number recited in a current reservation for said guest rental unit, displaying UNAVAILABLE on said visual display device.

16. The article of manufacture of claim 15, wherein said computer readable program code further comprises a series of computer readable program steps to effect if said credit card number matches a credit card number recited in a current reservation for said associated guest rental unit:
calculating a charge to rent said associated guest rental unit;
determining if said credit card number is authorized for said charge;
operative if said credit card number is authorized for said charge, receiving payment for said charge using said credit card number.

17. The article of manufacture of claim 16, wherein said computer readable program code further comprises a series of computer readable program steps to effect if said credit card number is not authorized for said charge, displaying a message on said visual display device that said credit card was refused.

18. The article of manufacture of claim 16, wherein said guest rental unit comprises a garage comprising a garage door, wherein said computer readable program code further comprises a series of computer readable program steps to effect opening said garage door.

19. The article of manufacture of claim 18, wherein said computer readable program code further comprises a series of computer readable program steps to effect providing electrical service to said guest rental unit.

20. The article of manufacture of claim 19, wherein said computer readable program code further comprises a series of computer readable program steps to effect:
determining if a payment period for said associated guest rental unit has expired;
operative if a payment period for said associated guest rental unit has expired, discontinuing said electrical service.
